(19) United States
(12) Patent Application Publication
(10) Pub. No.: US 2016/0066554 A1
(43) Pub. Date: Mar. 10, 2016

(54) INSECT ATTRACTANT

(71) Applicant: Edward Hom, North Olmsted, OH (US)

(72) Inventor: Edward Hom, North Olmsted, OH (US)

(21) Appl. No.: 14/833,177

(22) Filed: Aug. 24, 2015

Related U.S. Application Data
(60) Provisional application No. 62/048,601, filed on Sep. 10, 2014.

(51) Int. Cl. A01M 1/10

(52) U.S. Cl. CPC A01M 1/106

(57) ABSTRACT

A device and method for attracting and confining insects is disclosed. The device includes an insect attractant/confinement container comprising one or more small openings and a fermented fluid partially filling the insect attractant/confinement container.

### CROSS-REFERENCE TO RELATED APPLICATIONS

This application claims the benefit of U.S. Provisional Patent Application Se. No. 62/048,601 entitled “INSECT ATTRACTANT” filed on Sep. 10, 2014. The entirety of the above-noted application is incorporated by reference herein.

### ORIGIN

The innovation disclosed herein relates to insect control and more specifically, to a device that attracts and contains fruit flies.

### BACKGROUND

Houseflies and fruit flies and other insects are common pests that can be difficult to eradicate or control. In addition to being a nuisance, insects can render conditions unsanitary and spread disease. One example is in a restaurant environment where insects, particularly fruit flies, can be invasive around food and alcohol thus, creating potentially unsafe, not to mention, unattractive conditions.

A variety of conventional approaches have been used in an attempt to control flies, ranging from mechanical solutions (e.g., flyswatters, etc.) to the use of apple cider vinegar to soap based solutions to commercial products to attract, trap and dispose of fruit flies.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

In one aspect of the innovation, a device for attracting insects is disclosed that includes an insect attractant/confinement container comprising one or more small openings and a fermented fluid partially filling the insect attractant/confinement container.

In another aspect of the innovation, a fruit fly attractant/confinement container is disclosed that includes a body having at least one small aperture, a lid removably attached to the body, and a fermented fluid partially filling the body.

In still another embodiment of the innovation, a method for attracting insects is disclosed that includes partially filling an insect attractant/confinement device with a fermented fluid and attracting insects to the attractant/confinement device.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

Aspects of the disclosure are understood from the following detailed description when read with the accompanying drawings. It will be appreciated that elements, structures, etc. of the drawings are not necessarily drawn to scale. Accordingly, the dimensions of the same may be arbitrarily increased or reduced for clarity of discussion, for example.

FIG. 1 illustrates an example embodiment of a device that facilitates trapping flies in accordance with aspects of the subject innovation.

FIG. 2 illustrates another example embodiment of a device that facilitates trapping flies in accordance with aspects of the subject innovation.

FIG. 3 illustrates another example embodiment of a device that facilitates trapping flies in accordance with aspects of the subject innovation.

FIGS. 4-6 illustrate example test results comparing the innovative device to commercial and homemade devices in accordance with an aspect of the innovation.

FIG. 7 illustrates an example method of trapping flies in accordance with aspects of the subject innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

While specific characteristics are described herein (e.g., thickness), it is to be understood that the features, functions and benefits of the innovation can employ characteristics that vary from those described herein. These alternatives are to be included within the scope of the innovation and claims appended hereto.

While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

As mentioned above, fruit flies can create an unsafe and unsanitary conditions, not to mention an unattractive environment in an establishment such as a restaurant. Fruit flies are attracted to several items that give off a distinct aroma and/or gas. For example, fruit flies are attracted to carbon dioxide (CO₂) gases, which are a by-product of rotting fruit found in households and restaurants. Fruit flies are also attracted to fermented liquids, such as wine.

Commercial methods and devices for attracting insects, more specifically, flies (e.g., houseflies, fruit flies, etc.) are frequently expensive and of limited effectiveness. Home remedies, such as apple cider vinegar, can be as effective as commercially available products. Disclosed herein is an innovative system and method for attracting, trapping and disposing of insects (e.g., fruit flies) that includes the use of a fermented fluid (ethanol-based products), such as but not limited to alcoholic based liquids (e.g., sweet vermouth, dry vermouth, etc.) in accordance with an aspect of the innovation. The innovation can be more effective and less expensive than the conventional methods mentioned above.

In various aspects, the fermented fluid can be any of a variety of commercially available ethanol-based products (e.g., alcoholic beverages, apple cider vinegar, etc.). For example, testing conducted in connection with the subject innovation has indicated that sweet vermouth, dry vermouth, and bourbon are more effective than conventionally available fly attractants. In other examples, one or more fermented fluids can be mixed with one another (e.g., any of a variety of percentage mixtures of sweet and dry vermouth, etc.) or with one or more other chemicals (e.g., to create a denatured or methylated version of an ethanol-based product, etc.). In one example, embodiment, the insect attractant/confinement container can be a container (e.g., disposable, re-useable, etc.) capable of holding approximately 1 ounce (or 30 mL, etc.) of fermented fluid while maintaining space for air between the surface of the liquid and an upper surface of the insect attractant/confinement container (which may be applied later, depending on the embodiment), although smaller or larger containers can also be used in various embodiments.

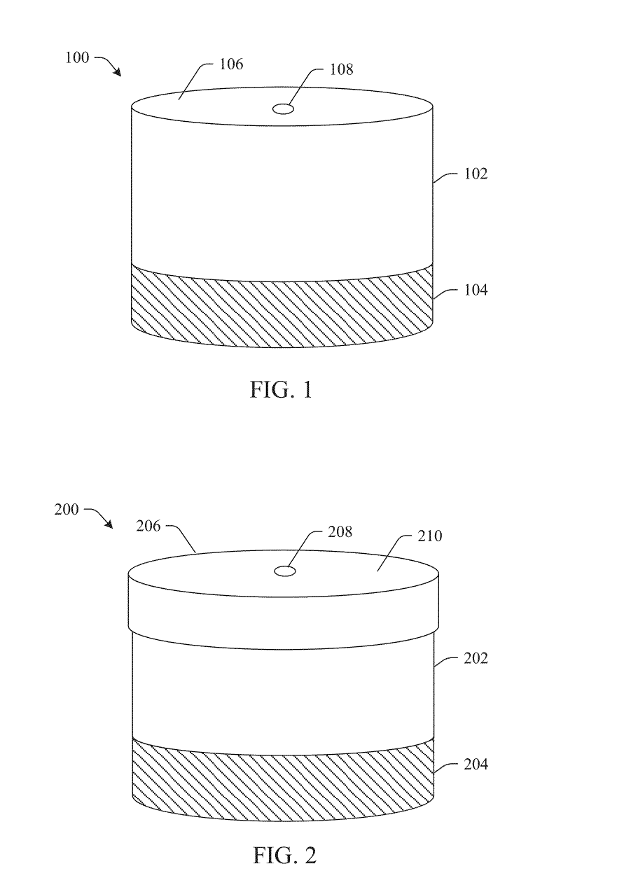

Referring now to the figures, FIG. 1 illustrates one example embodiment of an insect attractant/containment device (hereinafter “device”) 100 that facilitates trapping insects (e.g., flies, fruit flies, etc.) in accordance with an aspect of the innovation. The device 100 may be an integrated unit that includes an attractant/confinement container or body 102, which can be filled (partially or entirely) with a fermented fluid 104. The container 102 may be enclosed and have a circular, oval, polygonal cross section and include a top surface 106. Although for ease of illustration insect attractant/confinement container is depicted as cylindrical, as mentioned above, any of a variety of shapes can be employed while retaining the functionality of device 100.

One or more small openings or apertures 108 may be defined in the top surface 106 to allow insects to enter the device 100. Although FIG. 1 shows an example device with a single small opening 108 defined in the top surface 106, more than one can be employed in various embodiments. Further, although small opening 108 is defined in a top surface 106 of the device 100, in various embodiments, one or more small openings can be defined at any location on the surface of the device 100 that is above a level of the fermented fluid 104 contained therein.

FIG. 2 illustrates another example embodiment of an insect attractant/containment device (hereinafter “device”) 200 that facilitates trapping insects (e.g., flies, fruit flies, etc.) in accordance with an aspect of the innovation. The device 200 includes a container or body 202, which can be filled (partially or entirely) with a fermented fluid 204 and a removable lid 206. The body 202 and hence the lid 206 may have a circular, oval, polygonal cross section. Although for ease of illustration the insect attractant/confinement device 200 is depicted as cylindrical, any of a variety of shapes can be employed while retaining the functionality of the device 200.

The body 202 and removable lid 206 may include threads to thereby attach the removable lid 206 to the body 202. The removable lid 206 may also attach to the body 202 via any mechanical means, such as but not limited to snapping, twisting, etc. In addition, the removable lid 206 may be child proof to prevent the accidental removal of the lid 206 from the body 202. The removable lid 206 can be removed to fill/refill the body 202 with the fluid or to empty and clean the body 202 when full of insects.

In one example embodiment, one or more small openings or apertures 208 may be defined in a top surface 210 of the removable lid 206 to allow insects to enter the device 200. It is to be understood, that although FIG. 2 shows an example device 200 with a single small opening 208, more than one opening can be employed in various embodiments. Further, although the small opening 208 is depicted on the top surface 210 of the removable lid 206, in various embodiments, one or more small openings can be defined at any location on the surface of the device 200 that is above a level of the fermented fluid 204 contained therein.

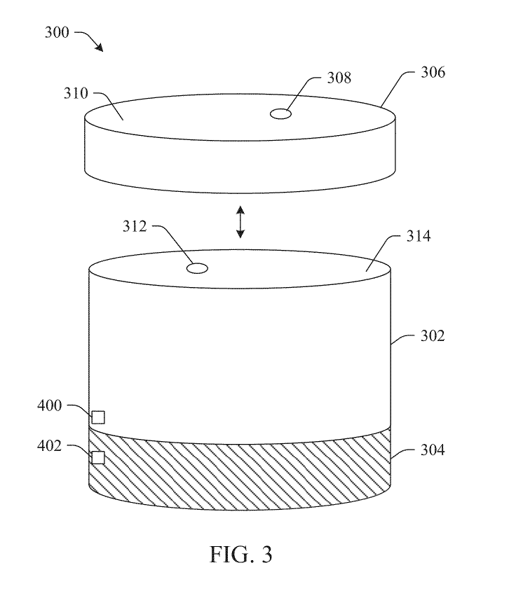

FIG. 3 illustrates another example embodiment of an insect attractant/confinement device (hereinafter “device”) 300 that facilitates trapping insects (e.g., flies, fruit flies, etc.) in accordance with an aspect of the innovation. The device 300 includes a container or body 302, which can be filled (partially or entirely) with a fermented fluid 304 and a removable lid 306. The body 302 and hence the lid 306 may have a circular, oval, polygonal cross section. Although for ease of illustration the insect attractant/confinement device 300 is depicted as cylindrical, any of a variety of shapes can be employed while retaining the functionality of the device 300.

The body 302 and removable lid 306 may include threads to thereby attach the removable lid 306 to the body 302. The removable lid 306 may also attach to the body 302 via any mechanical means, such as but not limited to snapping, twisting, etc. In addition, the removable lid 306 may be child proof to prevent the accidental removal of the lid 306 from the body 302. The removable lid 306 can be removed to fill/refill the body 302 with the fluid or to empty and clean the body 302 when full of insects.

In one example embodiment, one or more small openings 308 may be defined in a top surface 310 of the removable lid 306. In addition, one or more small apertures 312 may be defined in a top surface 314 of the body. In this example, the lid 306 may be rotated in a clockwise or counterclockwise direction until the opening 308 defined in the lid 306 is aligned with the aperture 312 defined in the top surface 314 of the body 302 to allow the insects to be attracted to the fermented fluid 304. The lid 306 can then be rotated in the opposite direction to seal the device 300 thereby preventing the insects from exiting the device 300.

It is to be understood, that although FIG. 3 shows an example device 300 with a single small opening 308 defined in the lid 306 and a single small aperture 312 defined in the top surface 314, more than one opening and aperture can be employed in various embodiments.

For the example embodiments described above, a variety of different sealing/unsealing configurations can be employed, depending on the embodiment. For example, the insect attractant/confinement device 100, 200, 300 can contain one or more perforated regions that can be opened to create one or more small openings in a surface of the insect attractant/confinement device 100, 200, 300 that is above a level of the fermentation fluid contained therein through which flies can enter the insect attractant/confinement device 100, 200, 300 while keeping the rest of the insect attractant/confinement device 100, 200, 300 enclosed, rendering it extremely difficult for flies to exit after having entered.

In other example embodiments, an upper surface of the insect attractant/confinement container can comprise a first surface with one or more small openings as described herein, and a second surface covering the one or more small openings and attached to the first surface via an adhesive. Upon removal of the second surface, the one or more small openings in the first surface can be exposed. In a further example, the insect attractant/confinement container can comprise an upper surface that a user can puncture with a pointed or sharp object (e.g., pin, tack, nail, fork, knife, etc.) to create the one or more small openings. In a further example, an upper surface of insect attractant/confinement container can comprise a first surface and a second surface that can move (e.g., rotationally, horizontally, etc.) relative to the first surface, such that in a first (e.g., initial, etc.) configuration, the first and second surface align to create a complete upper surface, but in a second configuration (e.g., for use, etc.), after moving the second surface relative to the first surface, one or more small openings can be created.

Still further, in other example embodiments, the device 100, 200, 300 may include indicators or sensors 400 (shown only in FIG. 3 for simplicity) to determine if the fermented fluid 304 has risen thereby indicating that the device 300 is full of insects thereby informing a consumer that the fermented fluid 304 requires changing. The indicator or sensor 400 can also measure the composition makeup of the fermented fluid 304 plus insects in the fermented fluid 304 to thereby provide an indication that the fermented fluid 304 needs to the changed.

Another indicator or sensor 402 can be provided to measure a level of the fermented fluid to determine if the fermented 304 is low and needs to be filled. The indicator or sensor can also measure a potency of the fermented fluid 304 to determine if the fermented fluid 304 requires changing.

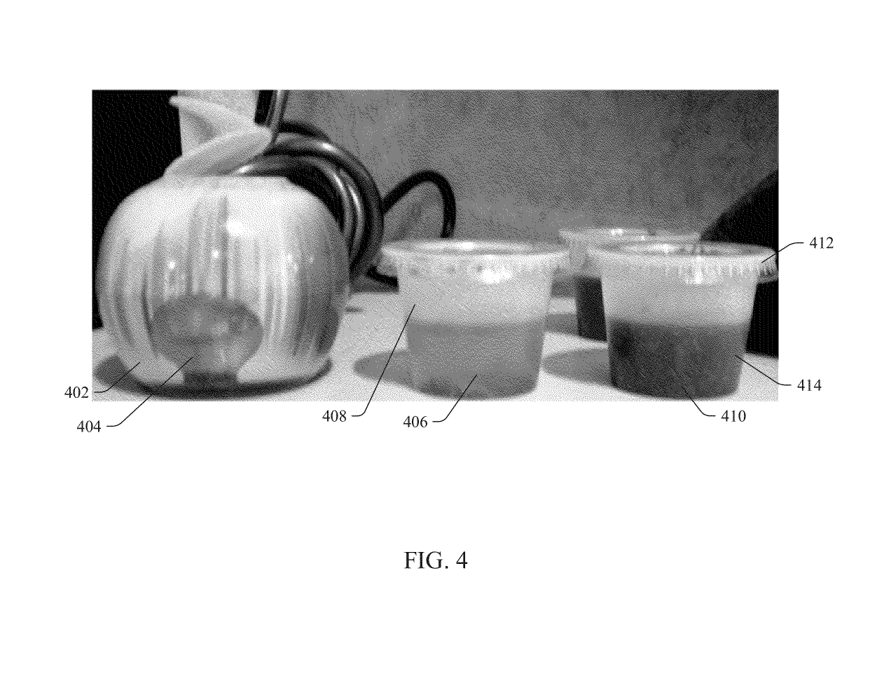

FIGS. 4-6 illustrate example test results comparing the innovative insect attractant/confinement container to conventional commercial fly attractant devices and a homemade device using apple cider vinegar. Specifically, referring to FIG. 4, a test between a first type of a conventional commercial fly attractant 402 having a commercial fluid 404, apple cider vinegar 406 disclosed in a test container 408, and the innovation disclosed herein using vermouth as the fermented fluid 410 disposed in a test container 412. Although all three fluids (the commercial fluid, the vermouth, and the apple cider vinegar) all start as clear fluids, as clearly illustrated in the figure the vermouth is now dark in color while the commercial fluid 404 and the apple cider vinegar 406 remain clear. The dark color 414 represents fruit flies that were attracted to the vermouth and are now confined in the container, whereas the clear fluids 404, 406 represent a lack of fruit flies. Thus, the vermouth 410 is clearly more effective than the commercial fluid or the apple cider vinegar.

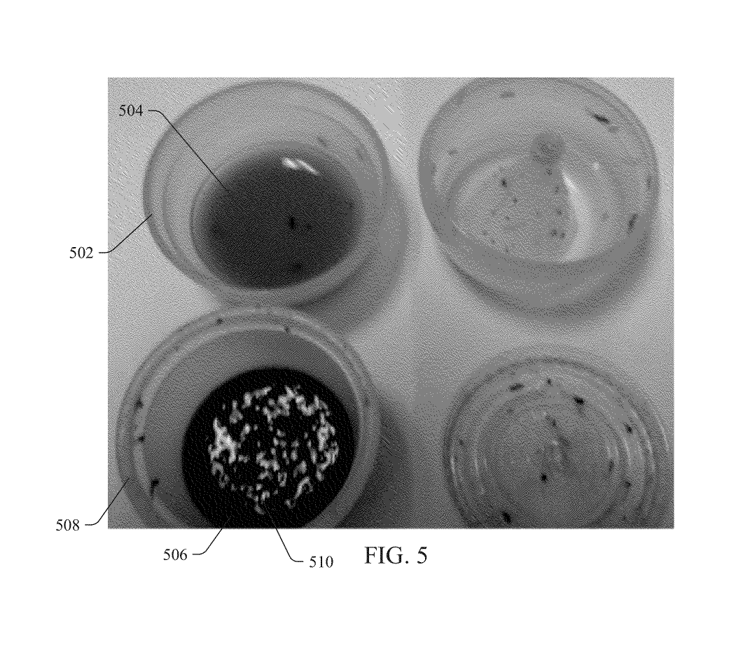

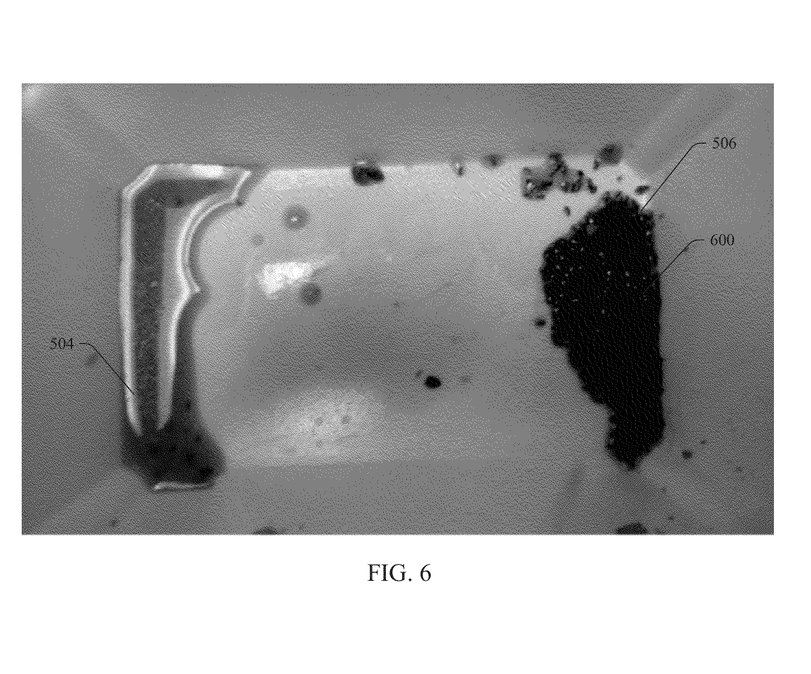

Referring to FIGS. 5 and 6, test results are illustrated comparing a second type of a conventional commercial fly attractant 502 having a second type of a commercial fluid 504 different from the first 404 and the innovation disclosed herein using vermouth as the fermented fluid 506 disposed in a test container 508. Although both the commercial fluid 504 and the vermouth 506 start as light colored or clear fluids, as clearly illustrated in the figure the vermouth is now dark in color and the commercial fluid 504 remains light in color. The dark color 510 represents fruit flies that were attracted to the vermouth and are now confined in the container, whereas the clear fluid 504 of the commercial fly attractant 502 represents a lack of fruit flies. Thus, the vermouth 506 is clearly more effective than the commercial fluid.

FIG. 6 illustrates the results shown in FIG. 5 on a white background to illustrate the effectiveness of the vermouth 506. The commercial fluid 504 is light in color and has little, if any, fruit flies therein. On the other hand, the vermouth has a large quantity of fruit flies 600 illustrated by the black color.

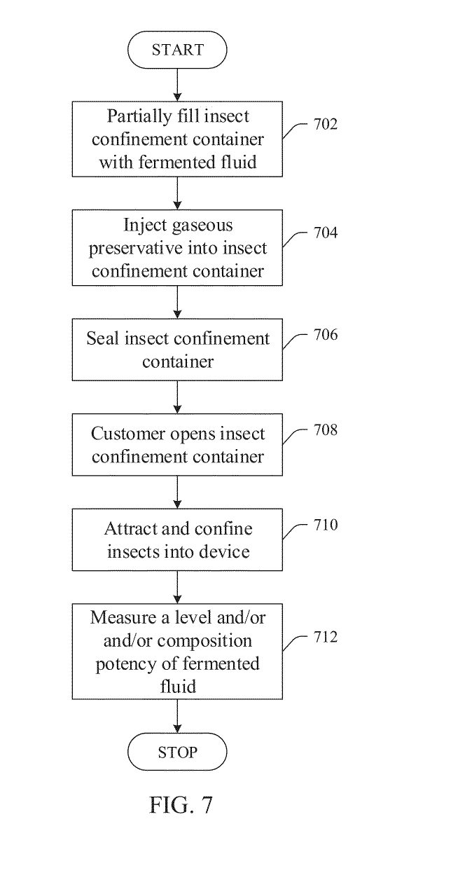

FIG. 7 is a block diagram illustration of a method 700 of trapping insects (e.g., flies, fruit flies, etc.) in accordance with aspects of the innovation. At 702, the device 100, 200, 300 described above is partially filled a fermented fluid as disclosed herein. At 704, an gaseous preservative may be injected into the insect attractant/confinement device 100, 200, 300, to prevent further oxidation of the fermented fluid prior to use. For example, nitrogen can be employed, as can various noble gases such as argon, etc. At 706, the insect attractant/confinement container can be sealed for later use. At 708, a user or customer unseals the insect attractant/confinement device 100, 200, 300. At 710, insects are drawn into the insect attractant/confinement device 100, 200, 300 by the scent of the fermented fluid, and will be trapped therein. At 712, a level and/or composition and/or potency of the fermented fluid can be measured to indicate if the fermented fluid requires changing as disclosed herein.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A device for attracting insects comprising:
an insect attractant/confinement container comprising one or more small openings; and
a fermented fluid partially filling the insect attractant/confinement container.

2. The device of claim 1, wherein the fermented fluid comprises one or more of sweet vermouth or dry vermouth.

3. The device of claim 2, wherein the insects are fruit flies.

4. The device of claim 1, wherein the one or more small openings is defined in a surface of the insect attractant/confinement container.

5. The device of claim 4, wherein the surface is a top surface of the insect attractant/confinement container.

6. The device of claim 5, wherein prior to use the one or more small openings is sealed and the insect attractant/confinement container is filled with a gas to prevent oxidation of the fermented fluid.

7. The device of claim 6, wherein the gas is nitrogen.

8. A fruit fly attractant/confinement container comprising:
a body having at least one small aperture;
a lid removably attached to the body; and
a fermented fluid partially filling the body.

9. The container of claim 8, wherein the fermented fluid comprises one or more of sweet vermouth or dry vermouth.

10. The container of claim 9, wherein the at least one small aperture is defined in a surface of the body.

11. The container of claim 10, wherein the surface is a top surface of the body.

12. The container of claim 11, wherein the lid includes at least one small opening defined in a top surface of the lid and wherein the lid rotates to align the at least one small opening with the at least one small aperture defined in the top surface of the body thereby allowing the fruit flies to be attracted to the fermented fluid.

13. The container of claim 8 further comprising a sensor to determine a level of the fermented fluid to determine if the fermented fluid requires changing.

14. A method for attracting insects comprising:
partially filling an insect attractant/confinement device with a fermented fluid; and
attracting insects to the attractant/confinement device.

15. The method of claim 14, wherein the fermented fluid comprises one or more of sweet vermouth or dry vermouth.

16. The method of claim 15, wherein prior to attracting insects to the attractant/confinement device the method comprising unsealing the insect attractant/confinement device.

17. The method of claim 16, wherein prior to unsealing the insect attractant/confinement device the method further comprising sealing the insect attractant/confinement container.

18. The method of claim 17, wherein prior to sealing the insect attractant/confinement container the method further comprising injecting a gaseous preservative into the insect attractant/confinement device.

19. The method of claim 18, wherein the gaseous preservative is a noble gas.

20. The method of claim 18, wherein the gaseous preservative is nitrogen.
